(19) United States
(12) Patent Application Publication
(10) Pub. No.: US 2021/0331422 A1
(43) Pub. Date: Oct. 28, 2021

(54) METHOD FOR CONNECTING TWO INDIVIDUAL FLUID TRANSPORT PIPE ELEMENTS USING RIGID SHELLS

(71) Applicant: SAIPEM S.A., Montigny Le Bretonneux (FR)

(72) Inventors: Giulio Fatica, Milano (IT); Taoufik Majdoub, Bobigny (FR)

(73) Assignee: SAIPEM S.A.

(21) Appl. No.: 17/368,423

(22) Filed: Jul. 6, 2021

Related U.S. Application Data
(62) Division of application No. 16/303,565, filed on Nov. 20, 2018.

(30) Foreign Application Priority Data
May 23, 2016 (FR) 1654582

(51) Int. Cl. B29C 65/16; B29C 65/00; F16L 1/26; F16L 13/02; F16L 58/18; F16L 59/20

(52) U.S. Cl. CPC B29C 65/1635; B29C 65/168; B29C 66/53241; B29C 66/547; B29C 66/72321; B29K 2105/165; B29C 66/73921; F16L 1/26; F16L 13/0272; F16L 58/181; F16L 59/20; B29C 66/727

(57) ABSTRACT

A method of connecting together two unit elements (4, 4′) of a fluid transport pipe, each unit pipe element being made of metal alloy and being covered in an outer insulating coating (6, 6′) made of a thermoplastic material, with the exception of an end portion that does not have an outer insulating coating, the method comprising a step of butt-welding together two unit pipe elements at their end portions having no outer insulating coating, a step of mechanically assembling at least two rigid shells (14, 16) made of a thermoplastic material on the end portions of the unit pipe elements not having an outer insulating coating, and a step of keeping the shells sealed against the outer insulating coating of the two unit pipe elements.

### CROSS REFERENCE TO RELATED APPLICATIONS

This application is a divisional of U.S. patent application Ser. No. 16/303,565, which was filed with the U.S. Patent and Trademark Office on Nov. 20, 2018 which is a U.S. national stage of application No. PCT/FR2017/051180, filed on May 16, 2017. Priority is claimed on France Application No. FR1654582, filed May 23, 2016, the content of which is incorporated herein by reference.

### BACKGROUND OF THE INVENTION

### 1. Field of the Invention

The present invention relates to the general field of fluid transport pipes, and in particular undersea pipes, resting on the sea bed or providing a bottom-to-surface connection for transferring hydrocarbons, e.g. oil and gas, coming from undersea production wells. The invention relates more particularly to connecting together two unit elements of such pipes.

These undersea pipes usually comprise a steel alloy tube that is covered in an outer insulating coating, typically a thermoplastic polymer, for limiting heat losses to the surrounding medium. The thickness of the outer coating varies depending on the operating conditions for the fluid that is to be transported (pipe length, fluid temperature, fluid composition, etc.).

In general, these pipes are assembled on land to form elements of unit length (referred to as double, triple, or quadruple joints, with the term “quad-joint”, which literally means quadruple sections of tube, being used below for any such unit length). These quad-joints are then transported at sea on a laying ship.

During laying, the quad-joints are connected to one another on board the ship progressively while they are being laid at sea. Laying may be performed using a J-lay or an S-lay tower positioned on the laying ship. With J-laying, the undersea pipe is typically lowered from the laying ship almost vertically (in the range +30° to 10° relative to the vertical). J-laying is simple catenary laying in which the almost vertical angle of inclination of the pipe diminishes progressively as it moves downwards until it matches the slope of the sea bottom. With S-laying, the undersea pipe is typically lowered from the laying ship almost horizontally and it curves subsequently in order to reach the sea bottom.

The J-lay and S-lay techniques require each new quad-joint to be connected on board the laying ship to the undersea pipe prior to being lowered into the sea by moving the laying ship. This step of connecting a new quad-joint to the undersea pipe is performed by butt-welding the free ends made of steel of the respective tubes of the new quad-joint and of the undersea pipe. Connecting together the new quad-joint and the insulated undersea pipe is made possible by a preliminary operation that is performed after the quad-joints have been coated in the factory, this operation consisting in removing the insulating coating at the ends over a defined length that enables welding and non-destructive inspection equipment to be deployed.

Once the ends have been welded together, it is necessary to use a new insulating coating to cover the zone of the pipe that includes the weld together with the portions of the tube of the pipe from which the outer insulating coating has been removed (which zone is referred to as the “cut-back”), and to do so while ensuring that this covering is put into place in a manner that is properly sealed to the remainder of the outer insulating coating of the pipe. For this purpose, the cut-back may be covered in several successive layers of different polymer materials. For example, after preparing the exposed steel surface by shot blasting, a relatively thin first layer forming a corrosion protection primary is applied directly to the cut-back, a thicker second layer of a polymer-based adhesive is applied on the adhesion primary, and a relatively thick third layer is applied on the adhesive out to at least the thickness of the coating that is already applied on the pipe. Alternatively, after depositing an adhesion primary on the cut-back, it is possible to apply the insulating material by injection molding.

That method of applying the outer insulating coating over the cut-back is referred to as “field joint coating”. Reference may be made to Document WO 2012/098528, which describes an example of such an application technique.

Nevertheless, that field joint coating technique presents a certain number of drawbacks. In particular, the time it takes is relatively long, and is thus constraining (typically of the order of 20 minutes (min) to 30 min per operation). When it involves injection molding of the material, that technique presents a problem of ensuring the molding adheres to the cut-back on the pipe, specifically the durability of the system depends on the success with which the molded joint adheres on the existing coating. Finally, it is an application technique that provides little flexibility.

### SUMMARY OF THE INVENTION

A main object of the present invention is thus to propose a method of connection that does not present the above-mentioned drawbacks of field joint coating.

In accordance with the invention, this object is achieved by a method of connecting together two unit elements of a fluid transport pipe, each unit pipe element being made of metal alloy and being covered in an outer insulating coating made of a thermoplastic material, with the exception of an end portion that does not have an outer insulating coating, the method comprising:

a step of butt-welding together two unit pipe elements at their end portions having no outer insulating coating;

a step of mechanically assembling at least two rigid shells made of a thermoplastic material on the end portions of the unit pipe elements not having an outer insulating coating; and

a step of keeping the shells sealed against the outer insulating coating of the two unit pipe elements.

The method of the invention is remarkable in that it uses rigid shells that are assembled on the cut-back of the insulating coating and that are fastened (directly or indirectly) to the outer insulating coating by weld bonding. These shells are suitable for being assembled to one another and to the end portions of the unit pipe elements that do not have any outer insulating coating, thus making it possible to ensure continuity of the insulating coating of the pipe. These shells may be made out of the same basic material as that of the outer insulating coating, thus making it possible to guarantee continuity of the insulating properties of the insulating coating over the connection zone between the two unit pipe elements.

The step of keeping the shells sealed may be performed by fusion-bonded coating. Under such circumstances, the time required for bonding the shells can be very short, of the order of about 3 min, which presents a considerable saving of time compared with the prior art field joint coating technique. In addition, by having recourse to bonding, keeping the shells on the cut-back presents no problem of adhesion with the end portions of the unit pipe elements. Finally, the method is applicable to any thermoplastic material used for making the outer insulating coating and to any dimensions for the unit pipe element.

Under such circumstances, each shell may be made of a thermoplastic material that is thermochemically compatible with the thermoplastic material of the outer insulating coating and may include at least one electrical resistance positioned at radial surfaces for bonding that are put into contact, during the step of keeping the shells sealed, with the outer insulating coating of the unit pipe element, and at a longitudinal surface for bonding that is to be put into contact with the other shell.

During the step of keeping the shells sealed, the electrical resistances of the shells are then connected to a source of electricity in order to cause the material constituting the shells to melt at the surface so as to provide sealed fastening of the shells to one another and against the outer insulating coating of the two unit pipe elements. This ensures firstly that the shells are kept sealed at their longitudinal ends against the outer insulating coatings of the two unit pipe elements, and secondly that the shells are fastened together in sealed manner.

The electrical resistance of each shell may be positioned in a single zigzag on the radial surfaces and on the longitudinal surface for bonding of the shell. Alternatively, each shell may include at least one electrical resistance positioned at one respective radial surface for bonding, and at least one other electrical resistance at a longitudinal surface for bonding that is to be put into contact with the other shell.

Alternatively, the step of keeping the shells sealed may be performed by laser-bonded coating.

Under such circumstances, the material constituting the shells may be transparent or translucent in order to allow the laser to pass through the shells to the surfaces for bonding, the laser bonding of the shells including positioning films of material that is absorbent at the wavelength of the laser between longitudinal contacting surfaces of the shells, and optionally positioning films of absorbent material between radial surfaces in contact of the shells and of the outer insulating coating of the two unit pipe elements when that coating is not made of an absorbent material.

In another implementation, the step of keeping the shells sealed comprises positioning an annular sleeve around the shells while they are mechanically assembled on the end portions of the unit pipe elements not having any outer insulating coating so as to cover both said shells and also portions of the outer insulating coatings of the unit pipe elements, said sleeve being made of the same material as a material constituting the outer insulating coatings of the unit pipe elements or out of a thermoplastic material that is thermochemically compatible therewith, and being fastened in sealed manner on the outer insulating coatings of the unit pipe elements by weld bonding.

The sleeve may be fastened in sealed manner on the outer insulating coatings of the unit pipe elements by fusion-bonded coating.

Under such circumstances, the sleeve may include at least one electrical resistance at an internal surface that, during the step of positioning the sleeve, is put into contact with the portions of the outer insulating coatings of the unit pipe elements that are covered by said sleeve and that is connected to a source of electricity in order to cause the surface of the material constituting the sleeve to melt so as to provide sealed fastening of the sleeve on the outer insulating coatings of the unit pipe elements.

Alternatively, the sleeve may be fastened in sealed manner on the outer insulating coatings of the unit pipe elements by laser-bonded coating.

Under such circumstances, the material constituting the sleeve may be transparent or translucent in order to enable the laser to pass through the sleeve to the surfaces for bonding, the laser bonding of the sleeve including positioning films of material that is absorbent at the wavelength of the laser between the contacting surfaces of the sleeve and of the outer insulating coating of the two unit pipe elements if the outer insulating coating is less absorbent than the sleeve.

Whatever the embodiment, the end portions of the two unit pipe elements that do not have outer insulating coatings may be obtained by machining, the shells presenting cut shapes at their longitudinal ends that are complementary to cut shapes of said end portions of the unit pipe elements.

Furthermore, the unit pipe elements are preferably made of steel alloy, the outer insulating coating and the shells being made on the basis of pure thermoplastic and/or on the basis of thermoplastic that is foamed or filled with hollow glass microspheres, or on the basis of thermoplastic that is thermochemically compatible with the outer insulating coating.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other characteristics and advantages of the present invention appear from the following description made with reference to the accompanying drawings, which show embodiments having no limiting character. In the figures:

FIGS. 1 to 3 show various steps in an implementation of a method of the invention for connecting together two unit undersea pipe elements;

FIG. 4 is a perspective view of two shells used for the technique of keeping sealed by fusion bonded coating;

FIG. 5 shows a variant of keeping the shells sealed by laser bonded coating; and

FIGS. 6A to 6C show another implementation for keeping the shells sealed to one another and to the outer insulating coating of two unit pipe elements.

### DETAILED DESCRIPTION OF THE PRESENTLY PREFERRED EMBODIMENTS

The invention applies to connecting together two unit elements of a pipe, in particular an undersea pipe, for transporting fluids such as hydrocarbons, e.g. oil and gas coming from undersea production wells.

A field of application of the invention is that single-pipe type undersea pipes, as contrasted to coaxial pipes known as “pipe-in-pipe” or “PIP”.

FIGS. 1 to 3 show an application of the invention to connecting together respective tubes 2 and 2′ of two unit elements 4 and 4′ (referred to below as “quad-joints”) of such an undersea pipe.

In known manner, the respective tubes 2, 2′ of these quad-joints are made of steel alloy and they are covered in respective outer insulating coatings referenced 6 and 6′, for limiting the loss of heat to the surrounding medium. Typically the outer insulating coating is constituted by a thermoplastic polymer, e.g. polypropylene, and it may be made up of various different layers of constitutions that may vary depending on operating conditions. By way of example, use may be made of a composition for an outer insulating coating that is made up of inner layers of polypropylene that is foamed or filled with hollow glass microspheres (referred to as “syntactic foam”) together with outer layers of pure polypropylene.

While the undersea pipe is being laid at sea, the quad-joints are connected to one another on board the laying ship progressively as they are laid at sea (where the laying may be of the J-lay or of the S-lay type). These laying techniques require each new quad-joint to be connected on board the laying ship to the quad-joint that has been most recently assembled to the undersea pipe prior to lowering it into the sea by moving the laying ship.

To this end, and as shown in FIG. 1, it is necessary initially to remove the outer insulating coatings 6 and 6′ from end portions of the tubes 2 and 2′ of the new quad-joint 4 for assembling and of the most recently assembled quad-joint 4′ of the undersea pipe.

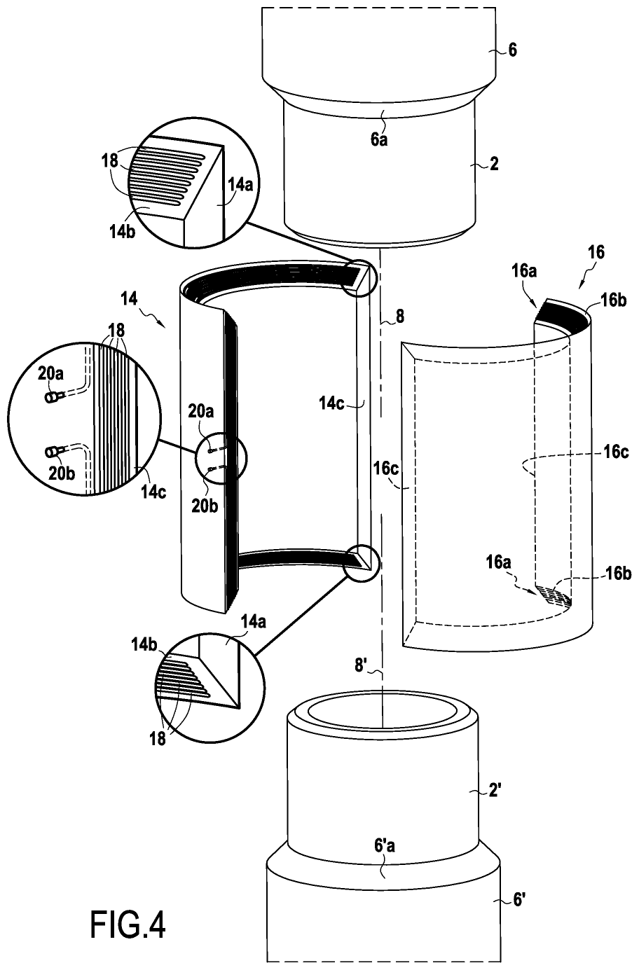

By way of example, this step is performed using various different mechanical techniques for machining the outer insulating coatings 6, 6′. This cutting away may lead to various cut shapes for the respective ends 6a and 6′a of the outer insulating coatings 6 and 6′. Thus, as can be seen more clearly in FIG. 4, these ends 6a and 6′a may be cut to have the shape of truncated cones. Alternatively, these ends may be given other shapes, such as for example a straight shape, a staircase shape, etc.

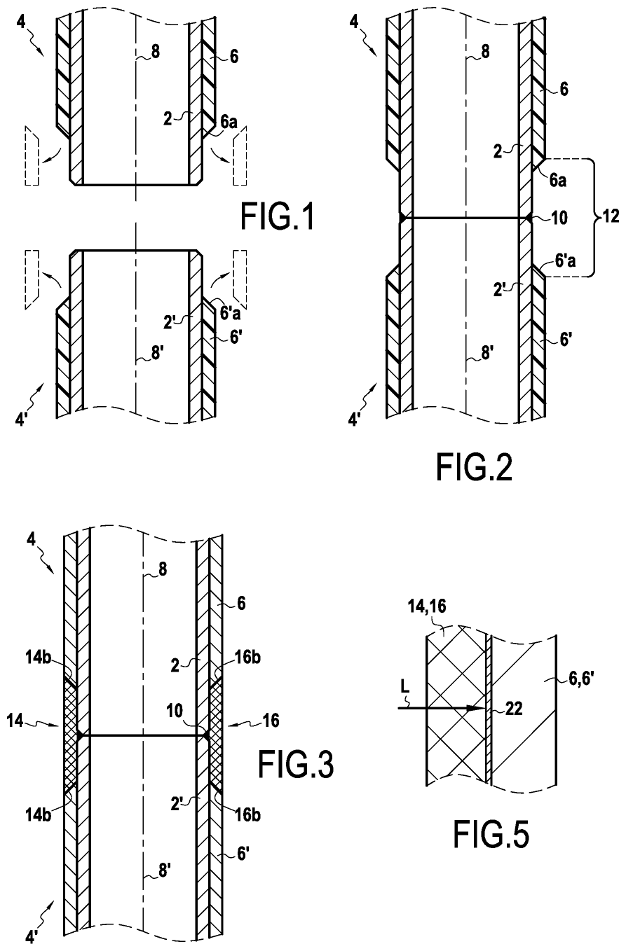

The following step of the connection method consists in aligning the longitudinal axis 8 of the new quad-joint 4 that is to be assembled with the longitudinal axis 8′ of the most recently assembled quad-joint 4′ of the undersea pipe and in moving these quad-joints towards each other so as to put the free ends of their respective tubes 2, 2′ into contact with each other (FIG. 2).

These steel tubes 2, 2′ are then welded together at their free ends so as to form an annular weld bead 10 between the tubes. This welding may be performed in one or more passes by any conventional welding technique, in particular by passing via the outside or via the inside of the quad-joints.

Once the tubes 2 and 2′ are thus welded together, they form an annular cut-back zone 12 where the insulating coating has been removed, which zone is defined longitudinally between the respective ends 6a and 6′a of the outer insulating coatings 6 and 6′.

Once the tubes 2 and 2′ have been welded together, the connection method of the invention provides for mechanically assembling at least two rigid shells 14 and 16 onto the cut-back 12, which shells are made of a material that is identical to a material constituting the outer insulating coating 6, 6′ of the quad-joints (FIG. 3).

Before this assembly, the annular surface of the cut-back 12 may need to be treated, e.g. by performing treatment to eliminate the slag resulting from the welding operation (by grinding) in order to obtain a surface that is perfectly smooth. Once the surface has been smoothed, it is also possible to apply thereon an anti-corrosion primary coating of epoxy or other type (not shown in the figures), with or without adhesive, so as to enable the shells to hold better on the tubes of the quad-joints.

FIG. 4 is a perspective view of an embodiment of shells 14 and 16 for assembling on the cut-back.

In this embodiment, the shells 14, 16 are two in number and they are in the form of symmetrical half-cylinders so as to make up a cylinder when they are assembled together on the cut-back. Naturally, the number of shells used for making up the cylinder by being assembled on the cut-back is not limited to two.

Furthermore, at their two longitudinal ends, these shells 14, 16 have cut shapes 14a, 16a that are complementary to the cut shapes at the respective ends 6a, 6′a of the outer insulating coatings 6, 6′. The conical shapes of these ends 6a, 6′a as shown in FIGS. 1 to 4 serve to improve coupling between the shells and the cut-back.

Furthermore, the shells 14, 16 are made of thermoplastic material that may be based on the same thermoplastic polymer as the polymer constituting the outer insulating coating or of a thermoplastic polymer that is thermochemically compatible. Thus, when the shells are assembled on the tubes of the quad-joints, they provide perfect continuity for the outer insulating coating of quad-joints.

In an embodiment, the shells 14, 16 are made entirely out of the same thermoplastic (e.g. a polypropylene) as that used for making the outer insulating coating 6, 6′. In another embodiment, the shells 14, 16 are of hybrid composition, i.e. their inner layers are made using the same thermoplastic material as the thermoplastic used for making the outer insulating coating (e.g. a polypropylene that is foamed or filled with hollow glass microspheres), while their outer layers are made with the same thermoplastic as that used for making the outer layer of the outer insulating coating (e.g. a pure polypropylene).

Once the shells 14, 16 have been mechanically assembled on the cut-back 12, provision is made to keep them there in totally sealed manner.

This step of keeping them in place in sealed manner may be performed by a fusion bonded coating technique or by a laser bonded coating technique.

Fusion-bonded coating consists in welding the shells 14, 16 directly to each other and to respective ends 6a, 6′a of the outer insulating coatings 6, 6′ by using one or more electrical resistances 18 integrated in the shells when they are fabricated, the shells being made of a thermoplastic material that is thermochemically compatible with the thermoplastic material of the outer insulating coatings.

Thus, as shown in FIG. 4, each shell 14, 16 may be provided with a single electrical resistance 18 positioned in a single zigzag both over both of the radial surfaces 14b, 16b formed at each longitudinal end of the shell at their cut shapes 14a, 16a, and also over one of the two longitudinal surfaces 14c, 16c extending between the shells 14a, 16a (only one of the two longitudinal surfaces of each shell is provided with an electrical resistance, with these two surfaces being opposite for the two shells).

More precisely, the electrical resistance 18 of each shell extends between two connectors 20a and 20b positioned side by side and approximately at equal distances from the two radial surfaces 14b, 16b. The electrical resistance thus extends from one of these connectors so as to run several times along one of the longitudinal surfaces 14c, 16c of each shell over its entire length, followed by both of its radial surfaces 14b, 16b, prior to going to the other connector.

While the shells 14, 16 are being fabricated, the electrical resistances 18 are integrated in them so as to be flush with the respective radial and longitudinal surfaces 14b, 16b and 14c, 16c of the shells.

During the step of securing the shells in sealed manner the electrical resistances 18 are connected via the connectors 20a, 20b to a source of electricity (not shown in the figures). The electrical energy supplied to the electrical resistances by the source of electricity is dissipated by the Joule effect, thereby having the effect of causing the surfaces of the material constituting the shells to melt. Intimate mixing together of the materials of the two shells (over their respective longitudinal surfaces 14c, 16c) and of the material of the shells with the material constituting the outer insulating coatings 6, 6′ of the tubes (at the radial surfaces 14b, 16c of the shells) thus serves to ensure perfect cohesion and sealing, firstly between the shells and secondly between the shells and these outer insulating coatings.

In this implementation, each shell has only one electrical resistance for performing fusion-bonded coating. Naturally, it is possible to envisage the shells having a plurality of electrical resistances forming a plurality of independent electrical circuits so as to be able to use different levels of electrical power depending on the zones being melted.

Alternatively, the step of fastening the shells in sealed manner may be performed by laser-bonded coating.

For this purpose, and as shown diagrammatically in FIG. 5, the material from which the shells 14 and 16 are made is transparent (or translucent) at the wavelength of the laser used for bonding. Given that the shells are transparent or translucent, films 22 of material that absorbs at the wavelength of the laser used are put into place between the respective longitudinal surfaces 14c, 16c of the two shells that are in contact with each other. In contrast, there is no need to position such absorbent films between the radial surfaces 14b, 16b formed at each longitudinal end of the shells at their cut shapes and at the respective ends 6a, 6′a of the outer insulating coatings 6, 6′ against which these radial surfaces come into contact, unless the material constituting the outer insulating coating is not absorbent at the wavelength of the laser.

As a result, during the step of sealed fastening of the shells, a laser beam L is directed towards the absorbent surface. The transparent nature of the shells 14, 16 allows the laser beams to pass through them in their thickness direction so as to reach the absorbent material (outer insulating coating or film 22, if necessary) at the surfaces that are to be bonded together, the material being absorbent at the wavelength of the laser beam L. Since this material (outer insulating coating or film) is absorbent, the contacting surfaces for bonding together are heated by absorbing energy from the laser, thus enabling them to be bonded together. The intimate mixing of the material from the two shells with each other (at their respective longitudinal surfaces 14c, 16c), and of the material of the shells with the material constituting the outer insulating coatings 6, 6′ (at their respective ends 6a, 6′a) serves to provide perfect cohesion and sealing, both between the shells and also between the shells and those outer insulating coatings.

It should be observed that the laser beam L may be applied to the shells from outside the pipe, e.g. using a laser directed towards the surfaces that are to be bonded together and that is capable of pivoting around the longitudinal axis of the pipe and of moving in translation longitudinally along the pipe so as to perform longitudinal bonding between the shells.

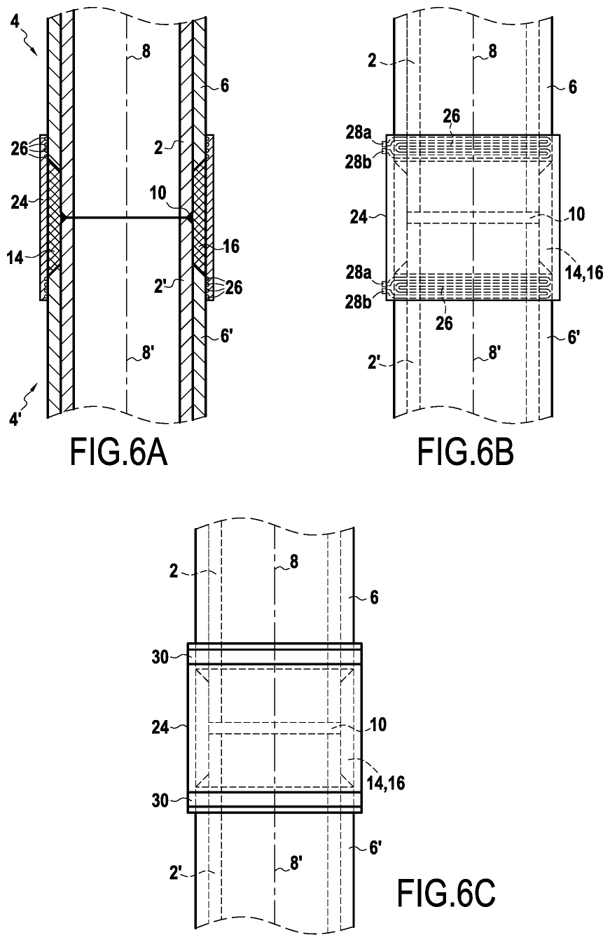

With reference to FIGS. 6A to 6C, there follows a description of another implementation of keeping the shells (indirectly) in sealed contact with the outer insulating coating on the two unit pipe elements.

In this implementation, the shells 14, 16 are assembled mechanically on the cut-back on the quad-joints, as described with reference to FIG. 3.

Once the shells have been assembled, and as shown in FIG. 6A, provision is made to position an annular sleeve 24 (of inside diameter slightly greater than the outside diameter of the assembled shells) around the shells so as to cover them completely and also cover portions of the outer insulating coatings 6, 6′ of the respective tubes 2, 2′ of the quad-joints (in other words, the sleeve projects longitudinally from both ends of the shells).

The sleeve 24 is made of the same material as the material constituting the outer insulating coatings 6, 6′ of the tubes of the quad-joints or out of a material that is thermochemically compatible therewith, and it is positioned on the shells by sliding it from a free end of the new quad-joint that is to be assembled towards the cut-back.

More precisely, in an implementation, the shells 14, 16 are made of thermoplastic, e.g. of pure polypropylene or foamed polypropylene or polypropylene filled with hollow glass microspheres (syntactic foam), and the sleeve 24 is made of pure thermoplastic (e.g. a polypropylene) of the same thermoplastic polymer as the polymer constituting the outer insulating coating or of a thermoplastic polymer that is thermochemically compatible. This implementation serves to improve thermal insulation.

In another implementation, the shells 14, 16 and the sleeve 24 are made of pure thermoplastic (no syntactic foam).

Once the sleeve 24 is in position, it is fastened in sealed manner to the outer insulating coating, either by fusion-bonded coating or by laser-bonded coating, so as to act indirectly to hold the shells in sealed manner on the outer insulating coating.

With fusion-bonded coating (FIG. 6B), the sleeve 24 incorporates a respective electrical resistance 26 on its inside surface and at each of its two longitudinal ends, this electrical resistance coming into contact with the portions of the outer insulating coatings 6, 6′ of the tubes that are covered by said sleeve.

During the bonding step proper, these electrical resistances are connected by pairs of connectors 28a, 28b to a source of electricity (not shown in the Figures) so as to give rise to surface melting of the material constituting the sleeve, suitable for fastening the sleeve in sealed manner on the outer insulating coatings of the two tubes of the quad-joints. More precisely, the Joule effect dissipation of the electrical power delivered to the electrical resistances has the effect of causing the material constituting the sleeve to melt at the surface. The intimate mixing of the material of the sleeve with the material of the outer insulating coatings of the tubes serves to provide perfect cohesion and sealing between the sleeve and those outer insulating coatings.

With laser-bonded coating (FIG. 6C), the material constituting the sleeve 24 is transparent or translucent at the wavelength of the laser used (not shown in FIG. 6C), and annular films 30 of material that is absorbent at the wavelength of the laser are positioned between the two longitudinal ends of the sleeve and the portions of the outer insulating coatings 6, 6′ of the tubes that are covered by said sleeve if the outer insulating coating is less absorbent than the sleeve. When the outer insulating coating is made of a material that is more absorbent than the sleeve material, such films are not necessary.

During the bonding step proper, the laser beam is applied to the absorbent material (outer insulating coating or film 30, if necessary). The transparent nature of the sleeve at the wavelength of the laser allows the laser beam to pass therethrough in the thickness direction in order to reach the absorbent material. Since this material (outer insulating coating or film 30, if necessary) is absorbent, the contacting surfaces for bonding together are heated by absorbing the energy of the laser, thereby enabling them to bond together. The intimate mixing of the material of the sleeve and the material of the outer insulating coatings of the tubes serves to ensure perfect cohesion and sealing between the shells and these outer insulating coatings.

Advantageously, before, during, or after the step of sealed fastening of the sleeve 24, external pressure of at least 1 bar is applied thereto so as to enable the sleeve to deform passively and fit closely to the outer profiles of the shells 14, 16 and of the portions of the outer insulating coatings 6, 6′ of the tubes that are covered by said sleeve.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of connecting together two unit elements of a fluid transport pipe, each unit pipe element being made of metal alloy and being covered in an outer insulating coating made of a thermoplastic material, with the exception of an end portion that does not have an outer insulating coating, the method comprising:
a step of butt-welding together two unit pipe elements at their end portions having no outer insulating coating;
a step of mechanically assembling at least two rigid shells made of a thermoplastic material on the end portions of the unit pipe elements not having an outer insulating coating; and
a step of keeping the shells sealed against the outer insulating coating of the two unit pipe elements that comprises positioning an annular sleeve around the shells while they are mechanically assembled on the end portions of the unit pipe elements not having any outer insulating coating so as to cover both said shells and also portions of the outer insulating coatings of the unit pipe elements, said sleeve being made of the same material as a material constituting the outer insulating coatings of the unit pipe elements or out of a thermoplastic material that is thermochemically compatible therewith, and being fastened in sealed manner on the outer insulating coatings of the unit pipe elements by weld bonding.

2. The method according to claim 1, wherein the sleeve is fastened in sealed manner on the outer insulating coatings of the unit pipe elements by laser-bonded coating.

3. The method according to claim 2, wherein the material constituting the sleeve is transparent or translucent in order to enable the laser to pass through the sleeve to the surfaces for bonding, the laser bonding of the sleeve including positioning films of material that is absorbent at the wavelength of the laser between the contacting surfaces of the sleeve and of the outer insulating coating of the two unit pipe elements if the outer insulating coating is less absorbent than the sleeve.

4. The method according to claim 1, wherein the end portions of the two unit pipe elements that do not have outer insulating coatings are obtained by machining, the shells presenting cut shapes at their longitudinal ends that are complementary to cut shapes of said end portions of the unit pipe elements.

5. The method according to claim 1, wherein the shells are made on the basis of pure thermoplastic and/or on the basis of thermoplastic that is foamed or filled with hollow glass microspheres, or on the basis of thermoplastic that is thermochemically compatible with the outer insulating coating.

6. The method according to claim 1, further comprising a step of applying external pressure on the sleeve.

7. The method according to claim 6, wherein the external pressure applied on the sleeve is at least 1 bar.

8. The method according to claim 6, wherein the external pressure is applied on the sleeve before, during, or after the step of sealed fastening of the sleeve.

9. The method according to claim 2, wherein the end portions of the two unit pipe elements that do not have outer insulating coatings are obtained by machining, the shells presenting cut shapes at their longitudinal ends that are complementary to cut shapes of said end portions of the unit pipe elements.

10. The method according to claim 2, wherein the shells are made on the basis of pure thermoplastic and/or on the basis of thermoplastic that is foamed or filled with hollow glass microspheres, or on the basis of thermoplastic that is thermochemically compatible with the outer insulating coating.

11. The method according to claim 2, further comprising a step of applying external pressure on the sleeve.

12. The method according to claim 7, wherein the external pressure is applied on the sleeve before, during, or after the step of sealed fastening of the sleeve.
